(19) United States
(12) Patent Application Publication
(10) Pub. No.: US 2005/0217154 A1
(43) Pub. Date: Oct. 6, 2005

(54) System of forming three-dimensional figures from a laminar material

(76) Inventor: Roberto Orellana Rodriguez, Metepec, Edo. de Mexico (MX)

Correspondence Address: FOLEY AND LARDNER;SUITE 500, 3000 K STREET NW, WASHINGTON, DC, 20007, US

(21) Appl. No.: 10/507,828

(22) PCT Filed: Mar. 14, 2003
(86) PCT No.: PCT/MX03/00028

§ 371 Date: May 16, 2005

(30) Foreign Application Priority Data
Mar. 14, 2002 (MX) PA/A/2002/002760

(51) Int. Cl. G09F 1/00

(52) U.S. Cl. 40/124.14

(57) ABSTRACT

The invention refers to a system for producing three-dimensional figures with different shapes, including irregular and/or asymmetric figures, as from flexible sheet materials, consisting in supplying a sheet piece having a major segment or body, as well as at least one tab created unitary to the body, at least one slot disposed in the body and at least one point of inflection, so that it bends or folds the sheet piece at the point of inflection and passes the tab through the slot, causing the desired effect of bulkiness, depression or different plane and providing volume to the sheet piece and therefore the creation of a three-dimensional figure. The system of the invention has several applications, such as in toys, promotional goods, decorative figures, educational material, etc.

### FIELD OF THE INVENTION

This invention relates to a system for producing entertainment three-dimensional figures with different shapes as from flexible sheet materials, which have several applications, just as in toys, promotional goods, decorative figures, educational material, etc.

### BACKGROUND OF THE INVENTION

The legendary art of origami for producing three-dimensional figures out of a sheet material, such as paper, is widely known. There are various publications which describe the most acknowledged techniques to construct a variety of three-dimensional figures. Even though this technique helps to develop manual skills as well as the person's talent (which means that it complies with educational and entertainment objectives), generally, the figures obtained only resemble the object that they intend to imitate, without really conforming clearly to the pretended figure. Besides, it does not permit to develop rounded parts and the volume that the figures obtain is relative, typically prevailing flat surfaces and straight edges, among other shortcomings. Furthermore, this technique usually employs a lot of steps to achieve the intended figure and requires of certain manual and intellectual dexterity to follow the steps and to fold the paper as needed.

Additionally, there are different systems based in the principles of origami, for example U.S. Pat. No. 8,248,428 B1 shows a system to facilitate the production of this type of three-dimensional figures, which uses printing as a fashion to indicate the areas that will end up on visible surfaces as well as the folding lines for showing how to fold the paper, but which lacks novelty regarding to the principles of this technique, that could allow its diversification or somehow to overcome the shortcomings described in the previous paragraph.

Likewise, other patents (for example: JP 7,068,059 and JP 3,009,781) are focused in methodologies that make easier or improve origami and they use as of previous printing of colors, sequences, numbers or instructions disposed in the surfaces, attached instruction sheets, up to software that associates it to the figure in matter, without furnishing solutions to the problems and restrictions above-mentioned.

Other techniques for the production of three-dimensional figures are limited solely to the elaboration of a specific shape, such as the ones described in U.S. Pat. Nos. 5,950,341 and 5,365,684, which focus in the construction of frameworks out of a sheet material, using folding joints and occasional insertions of legs and which do not contemplate the diversification to the construction of another figures, since they are specially designed for that particular object.

There are also other documents like U.S. Pat. No. 4,976,652, which describe the use of insertions of extended tabs with certain special shape (generally wider than the slot through which they basically cross), whose main object is the formation of stable bundles, representing in essence an alternative to the use of adhesives, reason why this technique itself is not contemplated as foundation for the construction of more than a few three-dimensional figures.

Likewise, a widely known technique is the one for constructing three-dimensional figures out of a sheet material which typically has printed the figure to develop and which has a design of edges or flanges that fasten to their counterpart by means of an adhesive or that eventually insert into their corresponding slots in order to provide volume to the figure, such as in U.S. Pat. No. 6,136,400. Nevertheless, this technique has the disadvantage of having the edges stretch to detach or to separate, requiring reassembling and/or re-gluing of the parts, causing their consumption and consequently, the figure's deformation. Furthermore, it does not permit to form very irregular or asymmetric figures that include depressions or bulkiness when starting from a single piece, since the final surface is generally flat and although insertion of additional pieces may eventually be used, these have a tendency to detach easily and because of their size, they are frequently lost, being inadequate for little children due to the risk of ingestion.

Among the products existing in the toys and promotional play-stuff market, are the products made from printed and die-cut sheet material, generally PVC, from which pieces are detached. The detached pieces, through the incisions made in the edges and in the drawing itself, form shapes in 3 planes (achieving the volume by means of perpendicular axes, without accomplishing expansion or depression of the characteristic material), that is, the sheet pieces having different shapes are placed perpendicularly to the piece where they must be affixed and at the elevation of each insertion, until forming a figure. Through this system, the image of the figure is somehow lost due to the effect of perpendicularity of planes and it is not really possible to achieve giving volume to the figure. Also, another disadvantage of this system is that the pieces easily detach producing a high risk of loss and even of ingestion of portions by small infants.

The Mexican Patent Application No. 9,408,512 suggests the generation of a three-dimensional effect referred to as “heightened realization” through superposition of planes with trimmed or die-cut surfaces which, once assembled and by means of a light-shade effect, impart a three-dimensional appearance. In this case, there are some limitations since the obtained figure is rather virtual (through the optical effects light/shade), reducing the interactivity to the panels assembly in order to provide said effect The abovementioned focuses in the manual activity in the generation of images with three-dimensional effect, and not as much in three-dimensional figures.

Therefore, there is a need for providing an educational and/or entertainment system that allows achieving three-dimensional figures with real volume, as from a sheet material (preferably of a single piece), so that they bear a close resemblance to the objects they attempt to imitate and that can be assembled without needing complicated instructions and without great manual dexterity required an even that preferably avoids the use of loose small pieces which represent a risk for little children.

### SUMMARY OF THE INVENTION

It is an object of the invention to provide a system for constructing different entertainment three-dimensional figures, including irregular and asymmetric shapes, as from flexible sheet materials, which allows bulkiness and depression of the material or a different plane, so that it generates a three-dimensional real figure.

Thus, it is also an object of the invention to provide a system for producing entertainment three-dimensional figures that do not require of great manual dexterity and which uses a minimum of instructions and stages to assemble or to construct the figure.

Additionally, we intend to provide a system to shape entertainment three-dimensional figures that avoids as much as possible, the use of adhesives to secure parts together.

Still more, in the preferred embodiment of the invention, we intend to provide a system that uses a single piece to shape the desired figure, so that it utmost prevents the use of small additional pieces (or detachment of small pieces of remainder material) not suitable for small children.

Another object of the invention is to provide a system for creating entertainment three-dimensional figures as from sheet materials, in which the pieces can be produced to an attractive cost and that can be diversified towards different consumers or objectives.

Another additional object of the invention is to provide a system for creating entertainment three-dimensional figures in which the pieces to assemble can take advantage of additional elements, as printing or association of plastic elements (for example painting, sculpture or other different materials or related techniques), that enrich and improve the assemble figure.

These and other objects are achieved by means of the system of the invention, in which, a sheet piece with a major segment or body is provided, as well as at least one tab created unitary to the body, a plurality of points of inflection disposed on the sheet piece at predetermined points; a plurality of slots formed in the sheet piece a predetermined points, each slot being in correspondence and alignment with at least one of the plurality of points of inflection, so that the sheet piece is curved or folded at the points of inflection and the at least one tab passes through the slots in a predetermined order, causing therefore a desired effect of bulkiness, depression or additional plane and thus providing volume to the figure and consequently, the shape of a desired entertainment three-dimensional figure.

Moreover, the invention anticipates the formation of creases for a better conformation of the figure that tried to be constructed, which may be indicated by any means such as printing, die-cutting or through separated instructions and it also contemplates the inclusion of indications or signals which specify the sequences, categorization, course or direction of the insertions and creases.

### BRIEF DESCRIPTION OF THE DRAWINGS

FIGS. 1 to 1E show a first example of a entertainment three-dimensional figure assembly as from a sheet material, according to the invention

FIGS. 2 to 2D show a second example of a entertainment three-dimensional figure assembly as from a sheet material, according to the invention.

FIGS. 3 to 3D show a third example of a entertainment three-dimensional figure assembly as from a sheet material, according to the invention.

FIGS. 4 to 4C show a fourth example of a entertainment three-dimensional figure assembly as from a sheet material, according to the invention.

FIGS. 5 to 5D show a fifth example of a entertainment three-dimensional figure assembly as from a sheet material, according to the invention, applied to a rocket design.

### DETAILED DESCRIPTION OF THE INVENTION

The system of the invention, with the help of different examples that illustrate the principles and fundamental elements of the invention, will now be described. Basically, the system of the invention for assembling entertainment three-dimensional figures as from a sheet material anticipates the inclusion of elements like tabs, slots and creases in a body-base of the figure that is intended to construct. These elements can be disposed anywhere where they are required and as well, can be repeated whichever times as needed. The disposition and shape of tabs, slots and creases, will depend on the final desired figure and on the sites where wish to add volume.

### EXAMPLE 1

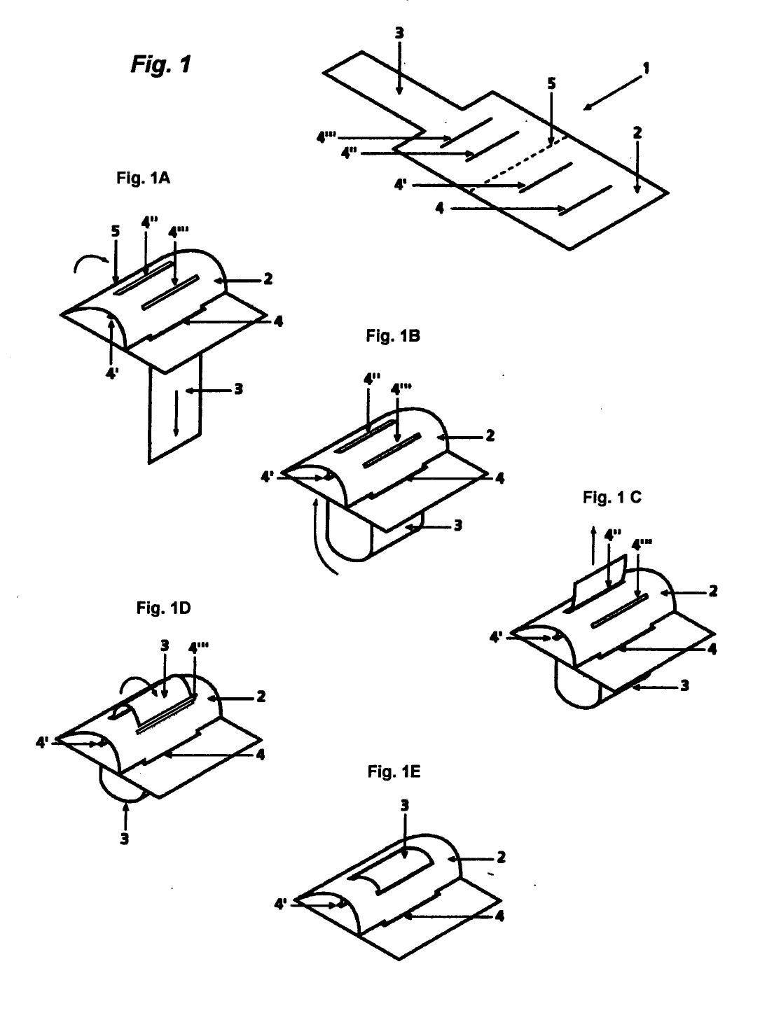

FIG. 1 shows a sheet piece 1 having a major segment or body 2, and a tab 3 created unitary to the body and slots 4, 4′, 4″ 4′″ shaped in the body, as well as point of inflection 5, which may be indicated by means of a dotted line, die-cut or similar and which divides body 2 into a front portion and a rear portion.

In accordance with the principles of the invention, in the example of FIG. 1, tab 3 initially passes through slot 4, at the same time that a crease is accomplished in point 5, as indicated in FIG. 1A, conducting this way the rear portion of body 2 to an upper plane, producing a bulkiness. Immediately, as it is appreciated in FIG. 1B, tab 3 passes through slot 4′ and later on through slots 4″ and 4′″ (FIGS. 1C and 1D), producing a second bulkiness over the first one, as illustrated in FIG. 1E.

### EXAMPLE 2

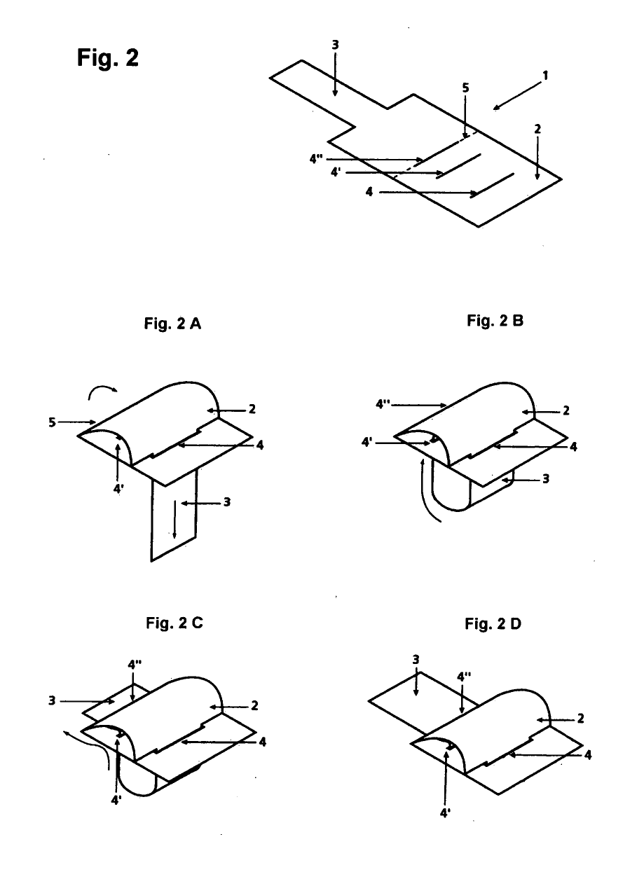

FIG. 2, just as in the example of FIG. 1, has arranged a body 2 with a tab 3, a point of inflection 5 and two slots 4 and 4′, but above the point of inflection, there is a slot 4″ set. The process of assembly in likewise similar to example 1 in its first two steps (FIGS. 2A and 2B), where tab 3 passes through slots 4 and 4′ and accomplishing a crease at point of inflection, 5, developing the rear portion of body 2 a bulkiness in the upper part, but in this case, as it is appreciated in FIG. 2C, the tab is passed afterwards through slot 4″ located at the point of inflection 5, ending in the rear portion of the body, developing only one bulkiness and leading the tab to come into being an element of the figure's rear portion.

### EXAMPLE 3

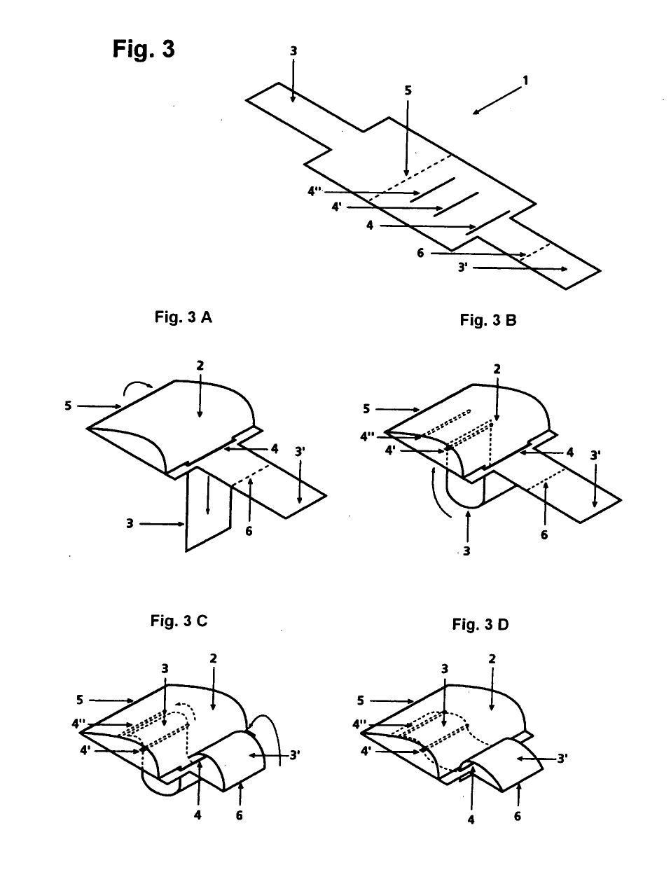

In the example illustrated in FIG. 3, there are provided two tabs 3 and 3′, in the rear and front ends of the body, respectively, a point of inflection 5, a second point of inflection 6 disposed in tab 3′ and three slots 4, 4′ and 4″ disposed in the front portion of body 2. Just as in the previous examples, as FIG. 3A shows, tab 3 passes through slot 4 accomplishing a crease at point of inflection 5, developing the rear portion of body 2 a bulkiness in the upper part. Afterwards, tab 3 passes through slots 4′ and 4″, achieving this way the development of a bulkiness in the lower part of the body (FIGS. 3B and 3C). FIGS. 3C and 3D, likewise show that tab 3′ folds at point of inflection 6 upwardly, in order to pass through slot 4, to develop a bulkiness in the front part of the figure.

### EXAMPLE 4

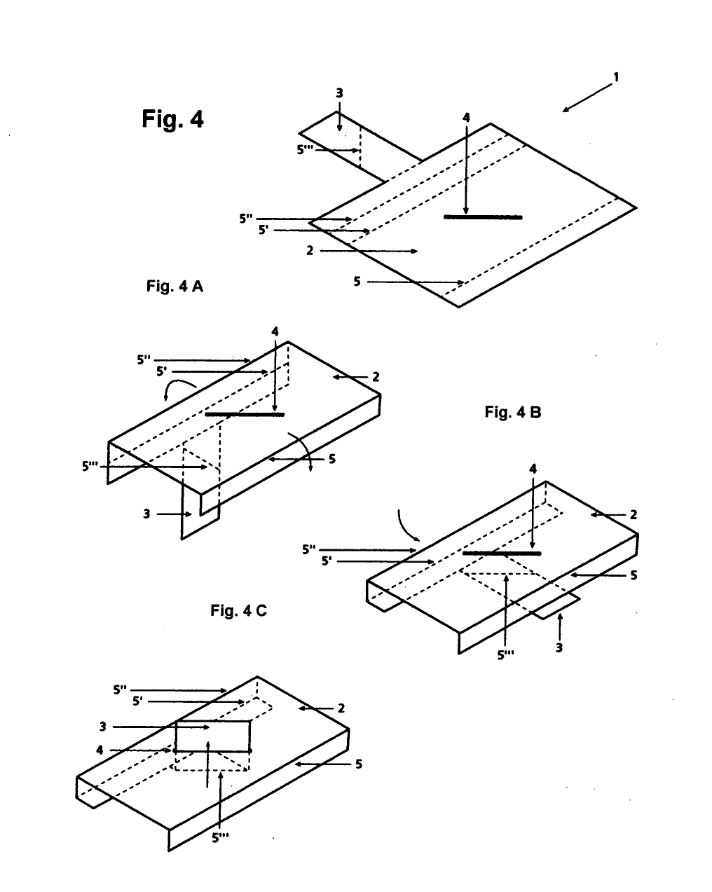

As shown in FIG. 4, this example provides a body 2 with a tab 3, a slot 4, four points of inflection 5, 5′, 5″ and 5′″, wherein creases will be accomplished, according to the following assembly process. In FIG. 4A, it can be seen that two creases are accomplished downwardly at the points of inflection 5 and 5′, in order to subsequently, as shown in FIG. 4B, accomplish a third crease of the body at point of inflection 5″, towards the lower face of the body, so that finally, as illustrated in FIG. 4C, a diagonal crease is accomplished over point of inflection 5′″, located in tab 3 this way passing tab through slot 4, ending in the upper part of body 2.

### EXAMPLE 5

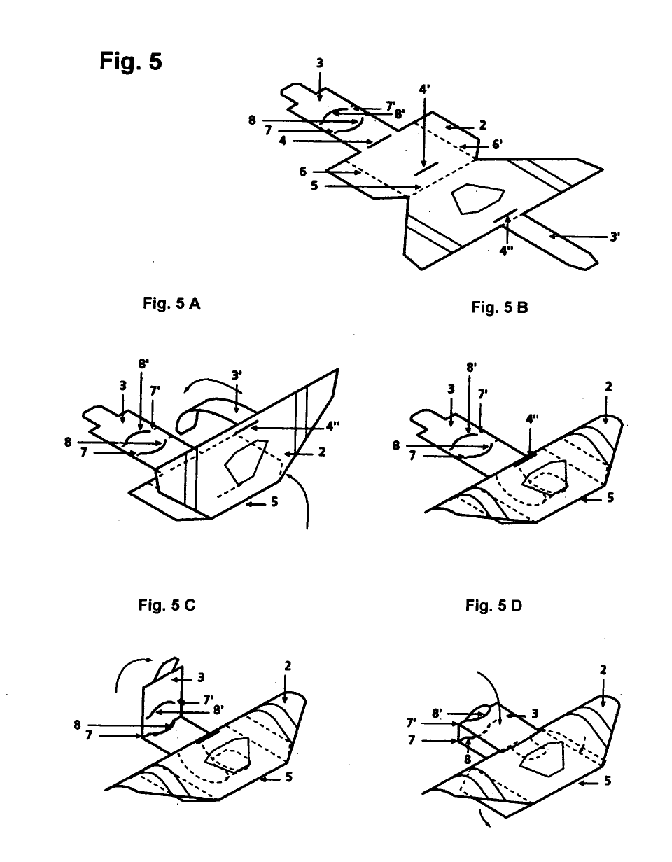

FIG. 5 illustrates an application of the system of the invention to design a rocket, wherein body 2 has a shape in which once the assembly is completed, it will give the desired appearance to the figure.

Body 2 illustrated in FIG. 5, is equipped with two tabs 3 and 3′, disposed at the rear and front ends of the body, as well as 3 slots 4, 4′ and 4″, five points of inflection 5, 6, 6′, 7 and 7′, and two curved slots 8 and 8′ disposed over points of inflection 7 and 7″.

The assembly process consists of accomplishing a crease in point of inflection 5, so that the front portion of body 2 folds over its rear portion, immediately, tab 3′ is introduced into slot 4, ending at the lower part of the body in order to insert it again into slot 4′. Afterwards, tab 3 folds at points of inflection 7 and 7′, in such a way that the remote end turns to the front part of the figure, as FIGS. 5C and 5D show, and the tab 3 end passes through slot 4″. Finally, two creases are accomplished in the rear portion of body 2 over points of inflection 6 and 6′ downwardly, as indicated in FIG. 5D.

It could be appraised that the elements herein described, may be combined and disposed in different ways in order to design sheet pieces that lead to the construction of different three-dimensional shapes, from the regular bodies to irregular and assymmetric figures.

Also, it will obvious that the sheet pieces may have the application of several ornamental elements, such as printing and engraving elements, including a combination of materials or techniques which provide the desired finishing or image.

It will be apparent to one skilled in the art that modifications or variations may be made to the invention herein described without departing from the spirit and scope of the invention, so it is to be understood that the herein described and illustrated arrangements are only illustrative and not limitative of the invention.

1. A system for producing entertainment three-dimensional figures as from a sheet material characterized in that it comprises: a sheet piece having a major segment or body, at least one tab created unitary to the body, a plurality of points of inflection disposed on the sheet piece at predetermined points, a plurality of slots formed in the sheet piece at predetermined points, each slot being in correspondence and alignment with at least one of the plurality of points of inflection, so that the sheet piece is bent at the points of inflection and the tab is passed through the slots in a predetermined order, taking a portion of the sheet piece or a portion of the tab to different planes, creating that way several volumes to conform a predetermined figure.

2. A system according to claim 1, characterized in that each of the body and at least one tab of the sheet piece has a shape and disposition according to the predetermined figure.

3. A system according to claim 1, characterized in that the points of inflection are indicated on the sheet piece by a mean selected among printing, die-cut or through separated instructions.

4. A system according to claim 1, characterized in that the sheet piece includes additional ornamental elements in order to confer a predetermined appearance to the assembled figure.

5. A system according to claim 4, characterized in that the additional ornamental elements are selected from printing elements, die-cut and plastic elements.

6-11. (canceled)

12. The use of the system according to claims 1 to 5, for the production of a toy.

13. The use of the system according to claims 1 to 5, for the production of promotional goods.

14. The use of the system according to claims 1 to 5, for the production of decorative figures.

15. The use of the system according to claims 1 to 5, for the production of education material.
